(19) United States
(12) Patent Application Publication
(10) Pub. No.: US 2023/0347562 A1
(43) Pub. Date: Nov. 2, 2023

(54) MOLD ASSEMBLY FOR THE PRODUCTION OF PET PREFORM AND SIMILAR PLASTIC PRODUCTS

(71) Applicant: FR MAKINA VE MOHENDISLIK ANONIM SIRKETI, Bursa (TR)

(72) Inventor: Ramazan AKAR, Bursa (TR)

(21) Appl. No.: 17/626,139

(22) PCT Filed: Sep. 22, 2020
(86) PCT No.: PCT/TR2020/050870

§ 371 Date: Jan. 11, 2022

(51) Int. Cl. B29C 45/56; B29C 45/26; B29B 11/08; B29C 33/74; B29C 33/38

(52) U.S. Cl. CPC B29C 45/56; B29C 45/261; B29B 11/08; B29C 33/74; B29C 33/3842; B29K 2105/258

(57) ABSTRACT

The invention relates to a mold assembly used in the production of plastic injection pet preforms and similar plastic products. The invention comprises the jaw (10) that forms the mouth of the PET preform on the injection mold and has the first conical jaw ring (70) on one side and the second conical jaw ring (80) on the other side, the cavity (20), which is locked to the side of the jaw (10) with the first conical jaw ring (70), by means of the cavity ring (50) connected to the upper surface and forming the outer wall of the PET preform, the locking ring (40) that is locked to the side of the jaw (10) with the second conical jaw ring (80) by means of the core ring (60) connected to its upper surface, the core (30) that is connected on the locking ring (40) and forms the inner wall of the PET preform.

### TECHNICAL FIELD

The invention relates to a mold assembly used in the production of plastic injection pet preforms and similar plastic products.

The invention espcially relates to a mold assembly that enables the abrasion problem on the conical locking surfaces of the plastic injection mold parts to be eliminated in pet preform production.

### PRIOR ART

PET (POLYETHYLENE TERAFTARAT), one of the basic materials of the plastic industry, is a raw material generally used in the production of beverage bottles such as soft drinks. Bottle production is generally a production method that includes a two-step process method, injection and then blow molding; due to speed, volume, logistics and economic factors. The basis of the two-step process method is based on the production of a preform with a structure similar to a test tube called PET preform in the injection process, and the principle of forming the PET preforms in cold mold with the help of compressed air and pushing piston in the blow molding machine by subjecting the PET preforms to a thermal process again.

In the current technique, abrasions occur on the conical locking surfaces of plastic injection mold parts in the injection process. The aforementioned abrasions on the conical locking surfaces of the mold, cause a deformation called burr in the PET preform obtained as a preform after the injection process. There are quality problems in the production of bottles produced from PET preform due to the aforementioned deformities. Although the abrasions that form these deformities occur only on the conical locking surfaces, all the parts that compose the mold, are produced completely again by machining methods and subsequent heat treatments. This causes high costs in the manufacture of each new part due to the consumption of raw materials, labor, energy and time. Therefore, in the state of the art, there has been a need for embodiments that enable the elimination of abrasions on the conical locking surfaces of the mold parts.

The document numbered EP1998945B1 can be shown as an example of the state of the art in the research conducted in the literature. Said document relates to blow injection molding tool. This device includes at least one mold that can be used for injection molding a thin-walled hollow preform that can be formed into a larger volume hollow body by blow molding. With the said mold structure, it is ensured to obtain a preform that allows the weight of thin-walled parts such as bottles to be reduced to a maximum while preserving their mechanical properties. The said mold generally includes an opposing mold that defines the inner surface of the cavity, a core placed in the cavity and spaced from this inner surface, a preform trail between the inner surface of the opposing mold and the core to receive the melted material, at least two main preferred flow channels (TAK) optionally includes at least two secondary preferred flow channels (TAK). However, it is not possible to eliminate the abrasions experienced on the mold parts with the said mold structure.

As a result, the existence of the above problems and insufficiency of existing solutions made it necessary to make an improvement in the related technical field.

### THE OBJECT OF THE INVENTION

The present invention relates to a mold assembly for the production of PET preforms and similar plastic products, which eliminate the above-mentioned disadvantages and bring new advantages to the relevant technical field.

The main object of the invention is to obtain a mold assembly that eliminates the abrasion problem on the conical locking surfaces of plastic injection mold parts in pet preform production.

The object of the invention is to prevent the need to completely replace the locking ring, jaw or cavity in the abrasion that occurs during the combination of the jaw, cavity and locking ring, which is on the mold during the production of PET preforms, conical jaw ring, core ring and cavity ring are integrated to the joining surfaces to ensure that the abrasions that will occur over time are on the rings that can be changed.

Another object of the invention is, thanks to make fillet welding by applying suitable weld seams to the worn conical surfaces of the jaw, cavity, locking ring and core by laser welding machine or other welding methods, it is eliminated the need to replace the locking ring, jaw or cavity altogether in the abrasions that occur during the combination of the jaw with the cavity and the locking ring.

Another object of the invention is to eliminate the consumption of raw materials, labor, energy and time caused by the re-produced molds used in the production of PET preforms due to abrasion.

In order to fulfill all the purposes stated above and that can be derived from the detailed description, the invention relates to the mold assembly used in the production of plastic injection pet preforms and similar plastic products. The invention is characterized by comprising as follows;
the jaw, which is located on the injection mold to form the mouth of the PET preform, including circular bulge, on its lower surface, extending upwards and downwards in accordance with the mouth structure of the PET preform, it further includes jaw channel in the form of an inward recess around the outer edge of the bulges,
the first conical jaw ring located in the jaw channel on one side of the jaw and whose outer surface is conical form,
the second conical jaw ring located inside the jaw channel on the other side of the jaw and whose outer surface is conical form,
the cavity, which is locked to the side of the jaw wherein the first conical jaw ring is on said side, by means of the connected cavity ring on the cavity channel located on its upper surface and forming the outer wall of the PET preform,
the locking ring, which is locked to the side of the jaw wherein the second conical jaw ring is on said side, by means of the core ring connected to the locking channel located on its upper surface,
the core that is connected on the locking ring and forms the inner wall of the PET preform.

The structural and characteristic features and all the advantages of the invention will be understood more clearly thanks to the figures given below and the detailed description written by making references to these figures. Therefore, the evaluation should be made by taking these figures and detailed explanations into consideration.

### FIGURES TO HELP UNDERSTAND THE INVENTION

FIG. 1, is the cross-sectional view of the mold assembly of the invention.

FIG. 2, is the disassembled view of the jaw of the mold assembly, the first conical jaw ring and the second conical jaw ring.

FIG. 3a, is a perspective view of the jaw of the mold assembly, the first conical jaw ring and the second conical jaw ring in assembled form.

FIG. 3b, is the front view of the jaw of the mold assembly, the first conical jaw ring and the second conical jaw ring in assembled form.

FIG. 4, is the disassembled view of the cavity and cavity ring of the mold assembly.

FIG. 5a, is the perspective view of the cavity and the cavity ring of the mold assembly in assembled form.

FIG. 5b, is the sectional view of the cavity and the cavity ring of the mold assembly in assembled form.

FIG. 6, is the disassembled view of the locking ring and core ring of the mold assembly.

FIG. 7a, is a perspective view of the locking ring and core ring of the mold assembly in assembled form.

FIG. 7b, is the sectional view of the locking ring and the core ring of the mold assembly in assembled form.

FIG. 8a, the top perspective view of the jaw of the mold assembly in the alternative embodiment of the present invention.

FIG. 8b, the bottom perspective view of the jaw of the mold assembly in the alternative embodiment of the invention.

FIG. 9, is the perspective view of the cavity of the mold assembly in the alternative embodiment of the invention.

FIG. 10, is the perspective view of the locking ring of the mold assembly in the alternative embodiment of the invention.

FIG. 11, is the sectional view of the mold assembly in the alternative embodiment of the invention.

### EXPLANATION OF THE PART REFERENCES

10. Jaw
11. Bulge
12. Jaw channel
13. Jaw welding surface
20. Cavity
21. Cavity channel
22. Cavity welding surface
30. Core
40. Locking ring
41. Locking channel
42. Locking welding surface
50. Cavity ring
60. Core ring
70. First conical jaw ring
80. Second conical jaw ring

### DETAILED DESCRIPTION OF THE INVENTION

In this detailed description, the preferred alternatives of the inventive mold assembly are explained only for a better understanding of the subject and without any restrictive effect.

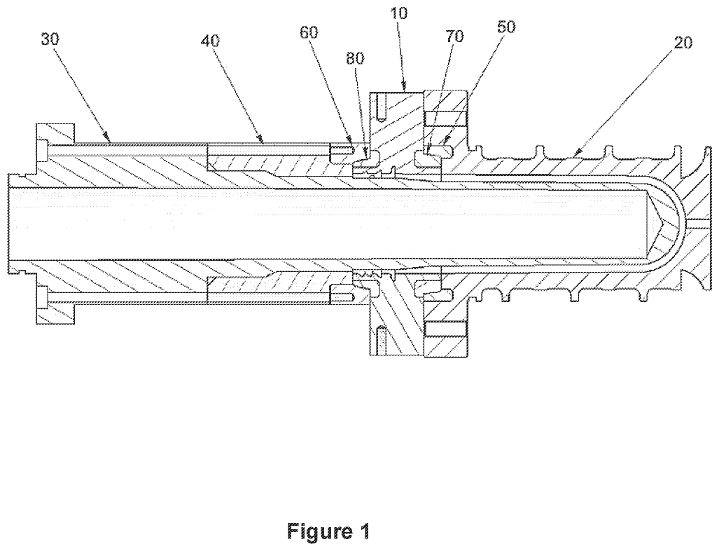

In FIG. 1, the sectional view of the mold assembly subject to the invention is given. Accordingly, the mold assembly generally comprises the jaw (10) that forms the mouth of the PET preform on the injection mold and has the first conical jaw ring (70) on its one side and the second conical jaw ring (80) on its other side, the cavity (20) which is locked to the side of the jaw (10) with the first conical jaw ring (70) by means of the cavity ring (50) connected to its upper surface and forming the outer wall of the PET preform, the locking ring (40) that is locked to the side of the jaw (10) with the second conical jaw ring (80) by means of the core ring (60) connected to its upper surface, the core (30) that is connected to the locking ring (40) and forms the inner wall of the PET preform.

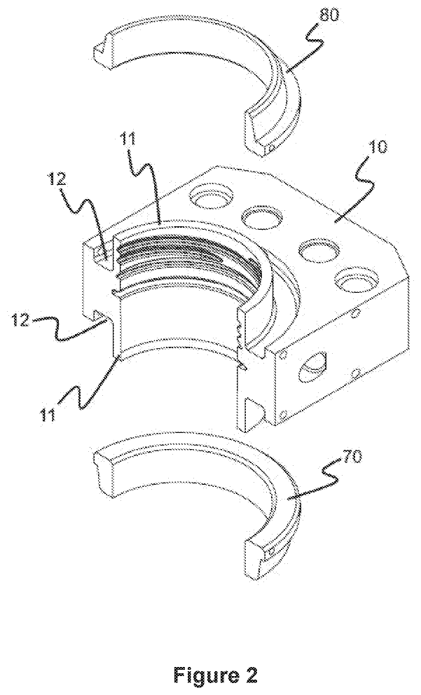

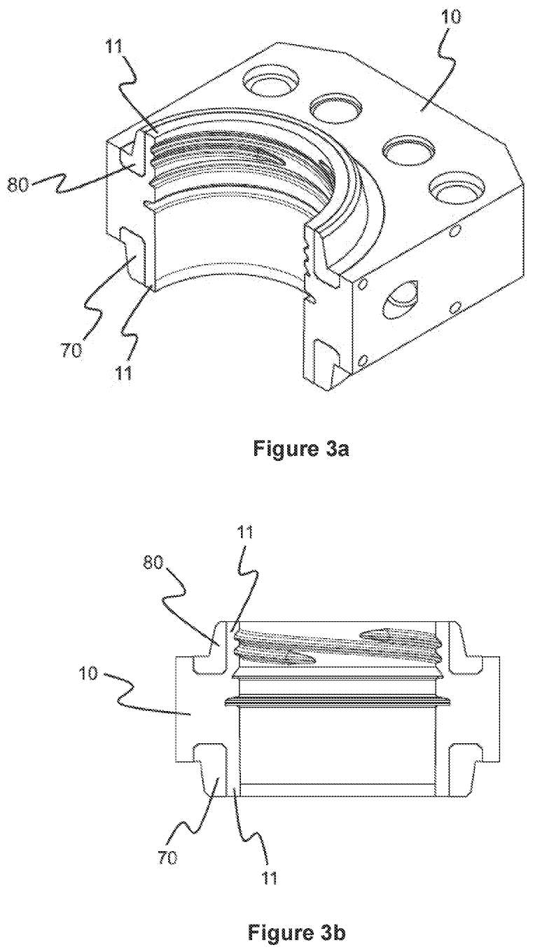

The jaw (10) is a movable structure located on the injection mold to form the mouth of the PET preform. As seen in FIG. 2, on the lower and upper surfaces of the jaw (10), there is a bulge (11) extending upwards and downwards in a circular form in accordance with the mouth structure of the PET preform. The jaw channel (12) in the form of an inward recess is opened around the outer edge of the bulges (11) extending upwards and downwards on the lower and upper surfaces of the jaw (10). The first conical jaw ring (70) and the second conical jaw ring (80), which have a circular and external conical form in accordance with the jaw channel (12), are embedded in the jaw channels (12) as seen in FIGS. 3a and 3b.

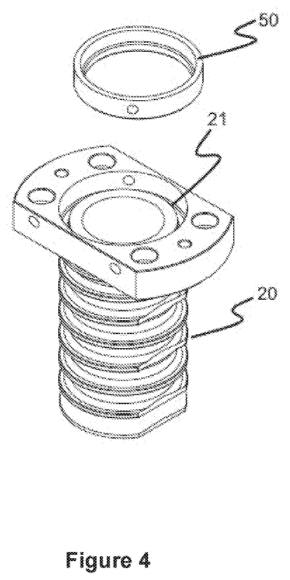

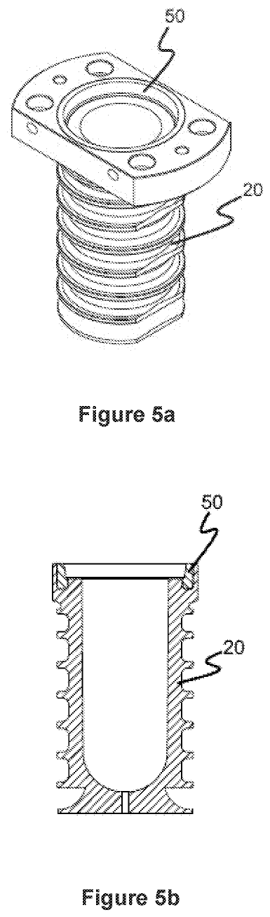

As seen in FIG. 4, a cavity channel (21) is opened on the upper surface of the cavity (20) forming the outer wall of the PET preform and, as seen in FIGS. 5a and 5b, a cavity ring (50) with a conical inner surface is embedded inside the cavity channel (21).

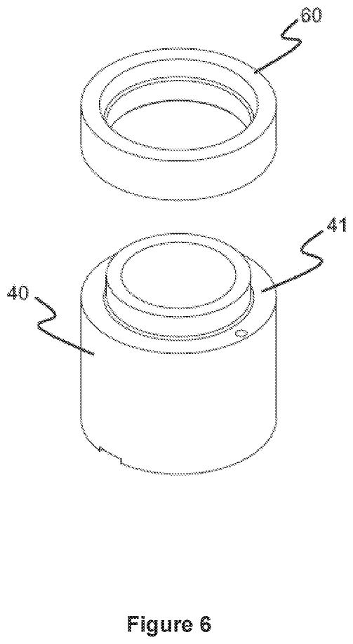

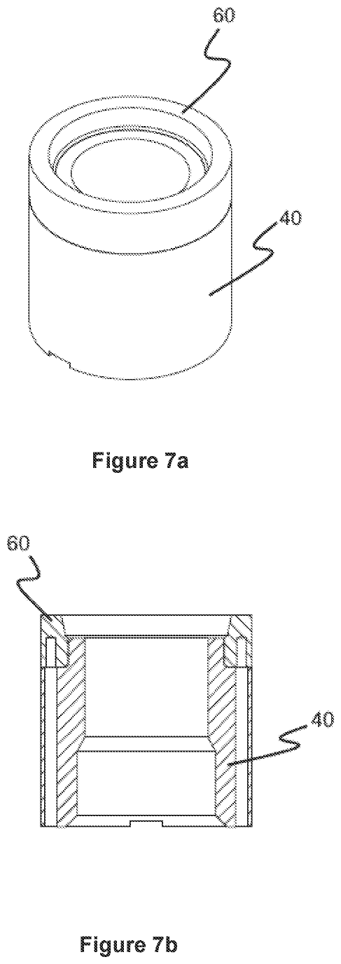

As can be seen in FIG. 6, a locking channel (41) is formed on the upper surface of the locking ring (40), which is in circular form, and the core ring (60) with a conical inner surface is connected on the said locking channel (41) as seen in FIGS. 7a and 7b. The locking ring (40) ensures the fixation of the core (30), which is placed in the cavity (20) passing through the jaw (10) to form the inner wall of the PET preform, on the jaw (10).

The Assembly of the Mold Assembly Subject to the Invention is Carried Out as Follows.

To form the mouth part of the PET preform, the jaw (10) which is located on the injection mold and has the first conical jaw ring (70) on one side and the second conical jaw ring (80) on the other side and the cavity ring (50) that is in connection with the upper surface of the cavity (20), is placed jaw (10) side on which the first conical jaw ring (70) is positioned. The cavity (20) forming the outer wall of the PET preform is locked to the jaw (10) by bearing the inner surface of the first conical jaw ring (70) in conical form inside the conical shaped cavity ring (50).

The locking ring (40) in connection with the core ring (60) from its upper surface, is placed on the side of the jaw (10) with the second conical jaw ring (80). The locking ring (40) is locked to the jaw (10) by bearing the inner surface of the second conical jaw ring (80) with a conical outer surface inside the core ring (60) in conical form. The mold assembly is made ready for use by connecting the core (30) forming the inner wall of the PET preform onto the locking ring (40).

During the production of PET preform, the need to completely replace the locking ring (40), jaw (10) or cavity (20) is prevented during the abrasion that occurs during the combination of the jaw (10) with the cavity (20) and the locking ring (40). By replacing the cavity ring (50), the core ring (60), the first conical jaw ring (70) and the second conical jaw ring (80), the abrasion problem has been eliminated.

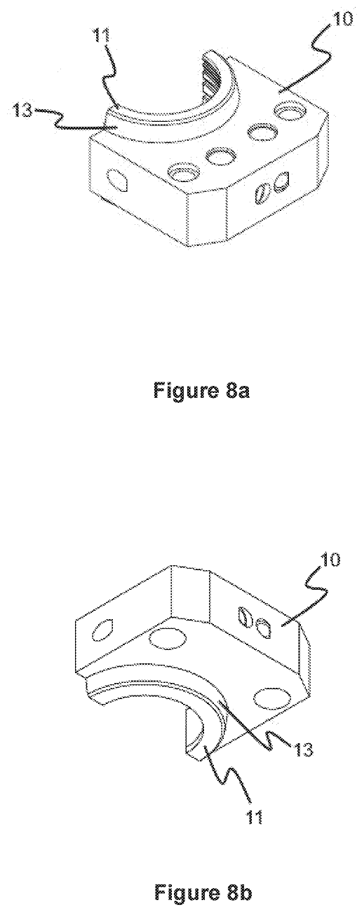

In the alternative embodiment of the invention, in order to prevent the abrasion that occurs during the combination of the jaw (10) with the cavity (20) and the locking ring (40), there are no jaw channels (12) around the outer edge of the bulges (11) on the lower and upper surfaces of the jaw (10) in accordance with the mouth structure of the PET preform. Filler welding is performed on the outer surface of the said bulges (11) by applying appropriate welding seams with laser welding machine or other welding methods as seen in FIGS. 8a and 8b. The weld seams thrown in sufficient thickness are then processed on suitable machining benches and the outer surfaces of the bulges (11) are turned into conical form, and the desired surface quality is achieved by obtaining the jaw welding surface (13) on the outer surface of the bulges (11). The same process is applied for the cavity (20) and the locking ring (40).

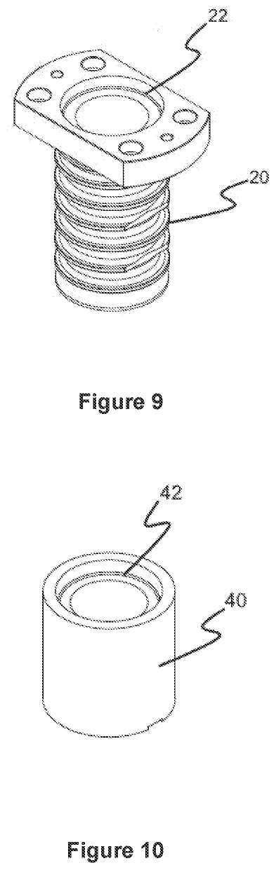

There is no cavity channel (21) on the upper surface of the cavity (20). Fill welding is performed on the upper inner surface of the cavity (20) by applying appropriate welding seams with laser welding machine or other welding methods as seen in FIG. 9. The weld seams thrown in sufficient thickness are then processed on suitable machining benches and the upper inner surface of the cavity (20) is turned into a conical form, and the cavity welding surface (22) is obtained on the upper inner surface of the cavity (20) and the desired surface quality is achieved.

There is no locking channel (41) on the upper surface of the locking ring (40). Filler welding is performed on the upper inner surface of the locking ring (40) by applying appropriate weld seams by laser welding machine or other welding methods as seen in FIG. 10. The weld seams thrown in sufficient thickness are then processed on suitable machining machines and the upper inner surface of the locking ring (40) is brought into a conical form, and the desired surface quality is achieved by obtaining the locking welding surface (42) on the upper inner surface of the locking ring (40).

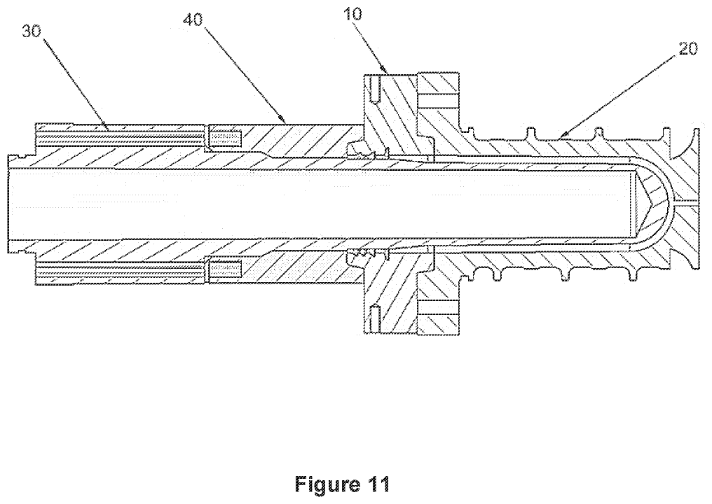

In the alternative embodiment of the invention mentioned above, the cavity (20) is placed on one side of the jaw (10) and the locking ring (40) on the other side, in order to fix the jaw (10), the cavity (20) and the locking ring (40) to each other, as seen in FIG. 11. In the meantime, the jaw welding surface (13) located on the outer surface of the protrusion (11) on one side of the jaw (10) is locked to the conical cavity welding surface (22) formed on the inner surface of the cavity (20) and the jaw welding surface (13) located on the outer surface of the protrusion (11) on the other side of the jaw (10) is also locked by engaging the conical shaped locking welding surface (42) formed on the inner surface of the locking ring (40) by engaging and the mold assembly is made ready for use.

1. Mold assembly used in the plastic injection pet preform production industry, characterized in that; it comprises,
the jaw (10), which is located on the injection mold to form the mouth of the PET preform, including circular bulge (11), on its lower surface, extending upwards and downwards in accordance with the mouth structure of the PET preform, it further includes jaw channel (12) in the form of an inward recess around the outer edge of the bulges (11),
the first conical jaw ring (70) located in the jaw channel (12) on one side of the jaw (10) and whose outer surface is conical form,
The second conical jaw ring (80) located inside the jaw channel (12) on the other side of the jaw (10) and whose outer surface is conical form,
The cavity (20), which is locked to the side of the jaw (10) wherein the first conical jaw ring (70) is on said side, by means of the connected cavity ring (50) on the cavity channel (21) located on its upper surface and forming the outer wall of the PET preform,
The locking ring (40), which is locked to the side of the jaw (10) wherein the second conical jaw ring (80) is on said side, by means of the core ring (60) connected to the locking channel (41) located on its upper surface,
The core (30) that is connected on the locking ring (40) and forms the inner wall of the PET preform.

2. Mold assembly according to claim 1, characterized in that; it comprises the first conical jaw ring (70) having conical outer surface, that enables the cavity (20) to be locked to the jaw (10) by being embedded in the cavity ring (50) with a conical inner surface.

3. Mold assembly according to claim 1, characterized in that; it comprises the second conical jaw ring (80) having conical outer surface, that enables the locking ring (40) to be locked to the jaw (10) by being embedded in the core ring (60) with a conical inner surface.

4. Mold assembly according to claim 1, characterized in that; it comprises jaw welding surface (13) with conical form, which is formed on the outer surface of the bulges (11) by means of the filler welding processed in machining machines and applied to the outer surface of the bulges (11) by laser welding machine or other welding methods by making suitable welding seams, in order to ensure that the said jaw (10) is connected to each other with the locking ring (40).

5. Mold assembly according to claim 1, characterized in that; it comprises locking welding surface (42) with conical form, which is formed on the upper-inner surface of the locking ring (40) by means of the filler welding processed in machining machines and applied to the upper-inner surface of the locking ring (40) by laser welding machine or other welding methods by making suitable welding seams, in order to ensure that the said jaw (10) is connected to each other with the locking ring (40).

6. Mold assembly according to claim 1, characterized in that; it comprises cavity welding surface (22) with conical form, which is formed on the upper-inner surface of the cavity (20) by means of the filler welding processed in machining machines and applied to the upper-inner surface of the cavity (20) by laser welding machine or other welding methods by making suitable welding seams, in order to ensure that the said jaw (10) is connected to each other with the cavity (20).
